(19) United States
(12) Patent Application Publication
(10) Pub. No.: US 2022/0291953 A1
(43) Pub. Date: Sep. 15, 2022

(54) DYNAMICALLY VALIDATING HOSTS USING AI BEFORE SCHEDULING A WORKLOAD IN A HYBRID CLOUD ENVIRONMENT

(71) Applicant: INTERNATIONAL BUSINESS MACHINES CORPORATION, Armonk, NY (US)

(72) Inventors: Abhishek Malvankar, White Plains, NY (US); John M. Ganci, JR., Raleigh, NC (US); Michael Spriggs, Ontario (CA); Carlos A. Fonseca, LaGrangeville, NY (US)

(21) Appl. No.: 17/200,598

(22) Filed: Mar. 12, 2021

(51) Int. Cl. G06F 9/48; G06F 11/30; G06K 9/62

(52) U.S. Cl. CPC G06F 9/4881; G06F 9/485; G06F 11/3006; G06F 11/3075; G06K 9/6267; G06K 9/6256

(57) ABSTRACT

A method, computer system, and a computer program product for host validation is provided. The present invention may include receiving a job from a user. The present invention may include selecting, by a scheduler, a host in a hybrid cloud environment to run the received job. The present invention may include classifying, by a learning component, the selected host's subsystems. The present invention may include determining, based on the classification, that the selected host can run the received job.

### BACKGROUND

The present invention relates generally to the field of computing, and more particularly to hybrid clouds.

Scheduling jobs in a hybrid cloud environment may be a time-expensive operation which involves job submission time and job queue time, among other things, before a job may be executed on a host. A job scheduler may be used to perform checks such as resource requirements of a job, host load levels, user quota, and user limits, prior to scheduling a workload and/or computationally expensive job in a hybrid cloud environment.

### SUMMARY

Embodiments of the present invention disclose a method, computer system, and a computer program product for host validation. The present invention may include receiving a job from a user. The present invention may include selecting, by a scheduler, a host in a hybrid cloud environment to run the received job. The present invention may include classifying, by a learning component, the selected host's subsystems. The present invention may include determining, based on the classification, that the selected host can run the received job.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for host validation according to at least one embodiment;

FIG. 3 is a block diagram of the training features of an autoencoder neural network according to at least one embodiment;

FIG. 4 is a block diagram of the score generated by an autoencoder neural network according to at least one embodiment;

FIG. 5 is a block diagram of a dataset on which named entity detection may be trained according to at least one embodiment;

FIG. 6 is a block diagram of internal and external components of computers and servers depicted in FIG. 1 according to at least one embodiment;

FIG. 7 is a block diagram of an illustrative cloud computing environment including the computer system depicted in FIG. 1, in accordance with an embodiment of the present disclosure; and

FIG. 8 is a block diagram of functional layers of the illustrative cloud computing environment of FIG. 7, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for host validation. As such, the present embodiment has the capacity to improve the technical field of hybrid cloud environments by dynamically determining which hosts present an anomaly with respect to workload requirements based on a neural network classification, and then feeding this information back into the scheduler so that jobs may not be scheduled on faulty (e.g., malfunctioning) hosts. More specifically, the present invention may include receiving a job from a user. The present invention may include selecting, by a scheduler, a host in a hybrid cloud environment to run the received job. The present invention may include classifying, by a learning component, the selected host's subsystems. The present invention may include determining, based on the classification, that the selected host can run the received job.

As described previously, scheduling jobs in a hybrid cloud environment may be a time-expensive operation which involves job submission time and job queue time, among other things, before a job may be executed on a host. Typically, a job scheduler may be used to perform checks such as resource requirements of a job, host load levels, user quota, and user limits, prior to scheduling a workload and/or computationally expensive job in a hybrid cloud environment. However, anomaly detection in hybrid cloud environments may be difficult due to the scale of the systems and the large number of components. Accordingly, there may be no check on the host's health status of various subsystems, including storage, memory, graphics processing unit (GPU), central processing unit (CPU), and/or drivers installed before the workload starts running, and hardware failure may be a resulting occurrence in these hybrid cloud environments.

Therefore, it may be advantageous to, among other things, dynamically determine which hosts present an anomaly with respect to workload requirements based on a neural network classification, and then feed this information back into the scheduler so that jobs may not be scheduled on faulty (e.g., malfunctioning) hosts.

According to at least one embodiment, a hybrid cloud environment, discussed above, may be an on-premises hybrid cloud environment running on computers on the premises of a person and/or organization and/or one or more public clouds which may have hundreds of hosts and complex computation systems. In a hybrid cloud environment, hardware failure may be a common occurrence which causes scheduled jobs to fail. Hardware failure may be reactive in nature, meaning that something may happen on the system which in turn causes the system to go down. A reactive hardware failure may not be predictable (e.g., a reactive hardware failure may be different than predicting when the system may be down).

Server hardware failures may be detected in hardware management logs (e.g., hardware failure logs obtained using SNMP for analysis).

Driver failures on a host and/or software or application incompatibilities may also result in failed jobs. For example, operating system driver failures in Linux® (Linux is a registered trademark of Linus Torvalds in the U.S. and/or other countries) and/or Kubernetes® (Kubernetes is a registered trademark of The Linux Foundation in the U.S. and/or other countries), among other operation systems, may be due to a missing driver, an incompatible application, and/or a wrong application version, among other things, which may cause the host to malfunction.

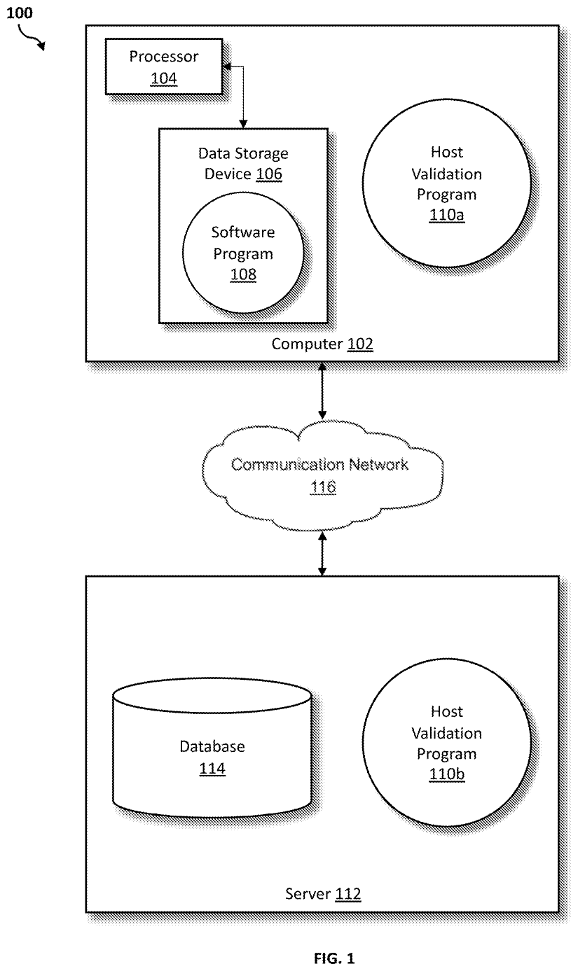

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a host validation program 110a. The networked computer environment 100 may also include a server 112 that is enabled to run a host validation program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

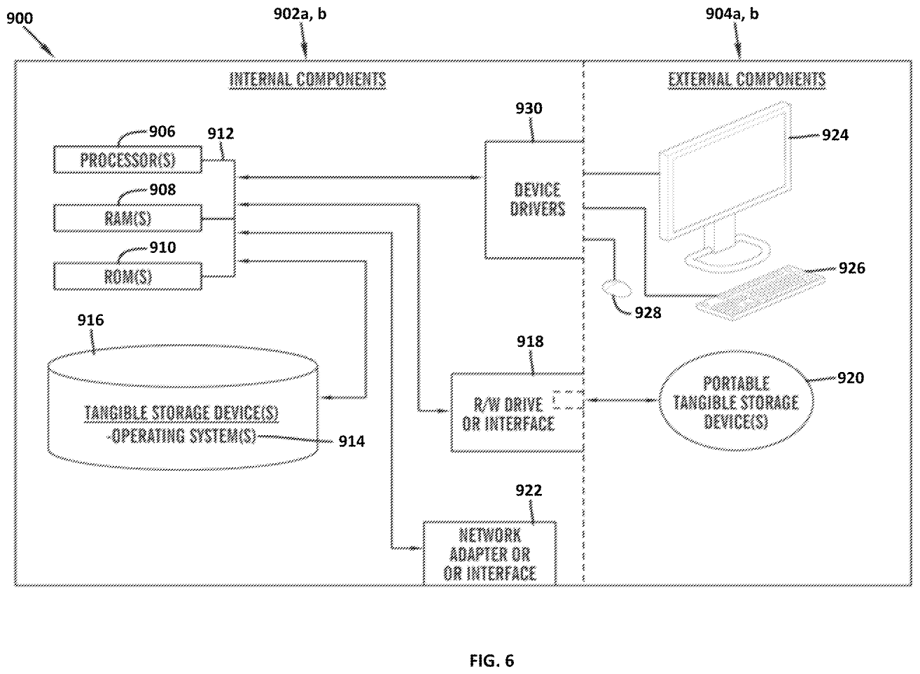

The client computer 102 may communicate with the server computer 112 via the communications network 116. The communications network 116 may include connections, such as wire, wireless communication links, or fiber optic cables. As will be discussed with reference to FIG. 6, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the host validation program 110a, 110b may interact with a database 114 that may be embedded in various storage devices, such as, but not limited to a computer/mobile device 102, a networked server 112, or a cloud storage service.

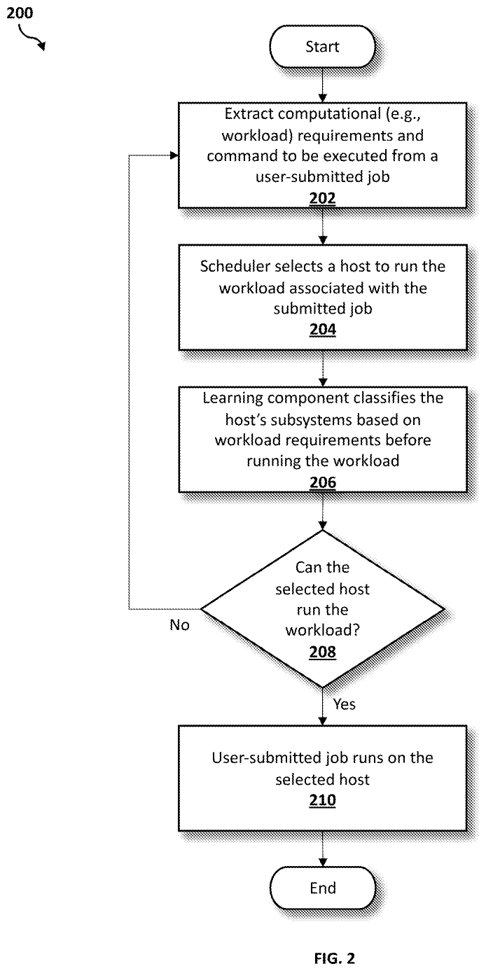

According to the present embodiment, a user using a client computer 102 or a server computer 112 may use the host validation program 110a, 110b (respectively) to dynamically determine which hosts present an anomaly with respect to workload requirements based on a neural network classification, and then feed this information back into the scheduler so that jobs may not be scheduled on faulty (e.g., malfunctioning) hosts. The host validation method is explained in more detail below with respect to FIGS. 2 through 5.

Referring now to FIG. 2, an operational flowchart illustrating the exemplary host validation process 200 used by the host validation program 110a and 110b according to at least one embodiment is depicted.

At 202, computational (e.g., workload) requirements and a command to be executed are extracted from a user-submitted job. The user-submitted job may include one or more commands and the associated computational requirements of the user-submitted job may relate to memory, graphics processing unit (GPU), central processing unit (CPU), and storage, among other things. A natural language processing system such as IBM's Watson™ (Watson and all Watson-based trademarks are trademarks or registered trademarks of International Business Machines Corporation in the United States, and/or other countries) may extract any associated computational requirements from the user's job (i.e., the user-submitted job).

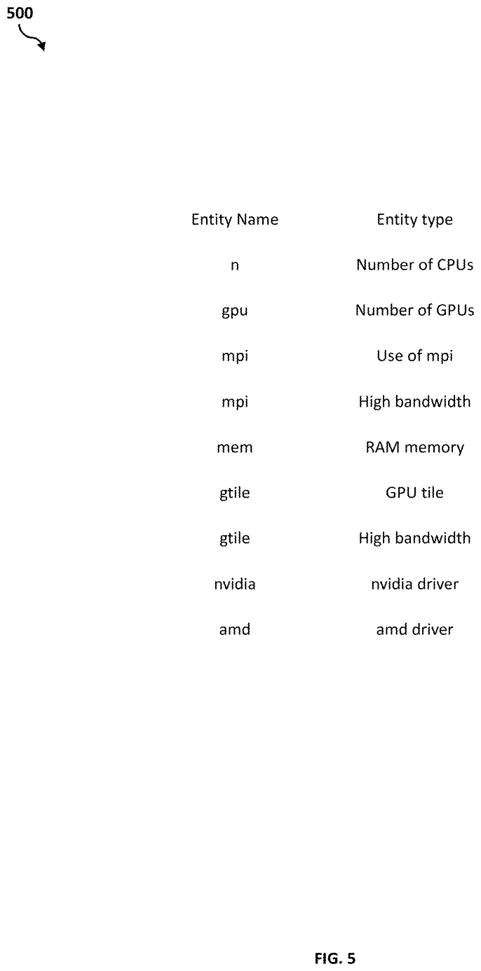

At the ingestion phase (e.g., receipt of the user-submitted job), entity extraction (e.g., entity name extraction, named entity recognition) may be performed on log files provided to the host validation program 110a, 110b by different subsystems and/or monitoring systems of the hybrid cloud environment. Ingestion may be a mechanism by which details of a user-submitted job and any associated job file(s) may be preprocessed to determine any relevant entities. Preprocessing may be a multistep approach including using standard natural language processing (NLP) techniques such as tokenization (e.g., where a user-submitted job is segmented into single-word and/or single-phrase tokens) and segmentation (e.g., where a user-submitted job is divided into meaningful segments, including words, sentences and/or phrases, etc.), among other things. Sentence tokenization may be a technique used to split a string of text into a list of tokens. A token may be a smaller component of a larger framework (e.g., a word within a sentence and/or a sentence within a paragraph). Here, the host validation program 110a, 110b extracts entities relevant to job scheduling which may be utilized in selecting a host on which to run the workload. The entity extraction technique (e.g., tokenization, segmentation, etc.) may be adapted to the relevant domain (e.g., based on the details and relevant components of the hybrid cloud environment) so that the entity extraction technique may be run on job scripts. For example, named entity detection may be trained on a dataset such as the one depicted in FIG. 5 below.

Named-entity recognition (NER) (e.g., named entity identification, entity extraction, entity chunking), a subtask of information extraction, may additionally and/or alternatively be used at the ingestion phase to locate and classify named entities mentioned in unstructured text into predefined categories. For example, as described above, when a user submits a job, the host validation program 110a, 110b may identify relevant portions of a job script relating to compute, storage, and/or networking requirements, among other things. The performance of entity extraction (e.g., entity detection on the user-submitted job) may enable the host validation program 110a, 110b to identify the types of subsystems the user may be attempting to use on a host.

Entity extraction may be a form of natural language processing (NLP) performed to identify how many subsystems exist and/or whether there are any known issues with the subsystems (e.g., with the CPU, GPU, etc.). Entity extraction may be an information extraction technique referring to the process by which key elements (e.g., elements from the log files relating to user compute, storage, and/or networking requirements) may be identified and classified into pre-defined categories.

A known issue identified here may include an exception and/or an error message in the log files provided by the different subsystems and/or monitoring systems of the hybrid cloud environment.

At 204, a scheduler suggests a host on which to run the workload associated with the user-submitted job. The scheduler may select a node from the hybrid cloud environment on which the user-submitted job may be executed based on the details extracted at step 202 above (e.g., based on requirements of the user-submitted job and capabilities of the hosts' subsystems).

For example, if a host has the requisite computational capabilities, then the scheduler may suggest to a user of the host validation program 110a, 110b that the host be used to run the user-submitted job. Furthermore, in addition to merely considering the computational capabilities of a host given the user-submitted job, the host validation program 110a, 110b may validate the host before running the user before running (i.e., executing) the job on the selected host. As described previously with respect to step 202 above, the validation process begins by extracting the user compute, storage, and/or networking requirements from log files of various subsystems provided by an autoencoder neural network using an entity extraction system. The validation process further includes an ensemble-based scoring method using various autoencoder neural networks, among other statistical and/or deep learning models, to score a host, as will be described in more detail with respect to step 206 below.

A hybrid cloud environment may have both a public component and a private component and a scheduler may be located within either component of the hybrid cloud environment. There may be one scheduler per hybrid cloud environment depending on implementation of the hybrid cloud environment. The scheduler in the hybrid cloud environment may communicate, in some circumstances, with a second scheduler in a second hybrid cloud environment. This will provide for additional hosts which may be used to execute the user-submitted job.

At 206, a learning component classifies the host's subsystems based on workload requirements before running the workload. The learning component may be a deep neural network (DNN) autoencoder and/or another statistical and/or deep learning model(s). The DNN autoencoder, for example, may predict whether the user-submitted job should be scheduled on the suggested host (as described previously with respect to step 204 above). If the host validation program 110a, 110b determines that a different host is preferred, then the DNN autoencoder may select a next best host based on the classifications of the host's subsystems. A next best host may be selected based on the validation process described with respect to steps 202 and 204 above. For example, as described previously with respect to step 202 above, the validation process may extract the user compute, storage, and/or networking requirements from log files of various subsystems provided by an autoencoder neural network using an entity extraction system. Then, as is described here, an ensemble-based scoring method using various autoencoder neural networks, among other statistical and/or deep learning models, may score the host relative to the host's ability to execute the user-submitted job.

Multiple jobs may be scheduled on a single host based on an availability of resources and/or requirements of the user-submitted job.

Feedback (e.g., regarding whether to schedule or not to schedule the user-submitted job on a suggested host) may come from the DNN autoencoder (e.g., a software component of the hybrid cloud environment) and may be provided to the scheduler (e.g., a second component of the hybrid cloud environment). Each time the DNN autoencoder (e.g., the trained DNN autoencoder) provides a prediction, the scheduler may be automatically updated. For example, as here, feedback may be generated by multiple machine learning autoencoder models belonging to different subsystems in the hybrid cloud environment (i.e., the ensemble method described herein). The feedback may then be transformed to a Boolean value by the host validation program 110a, 110b to indicate whether or not to execute the user-scheduled job on the selected host.

At least one autoencoder neural network (e.g., DNN autoencoder) may be trained for each component of the workload and/or hybrid cloud environment (e.g., CPU, GPU, memory, and/or device driver logs, among other components). An autoencoder may be a technique and/or classification mechanism used to determine something (e.g., a go or no-go for scheduling). An autoencoder may be a system trained on software logs which recreates an original input with very high accuracy when trained. However, if the autoencoder encounters an unseen input then the system may be unable to recreate the input which is substantially dissimilar from the normal input (e.g., activity which is ten times larger than the normal input may be determined to be an anomaly). The use of an autoencoder here may be one design implementation and other neural networks may be used.

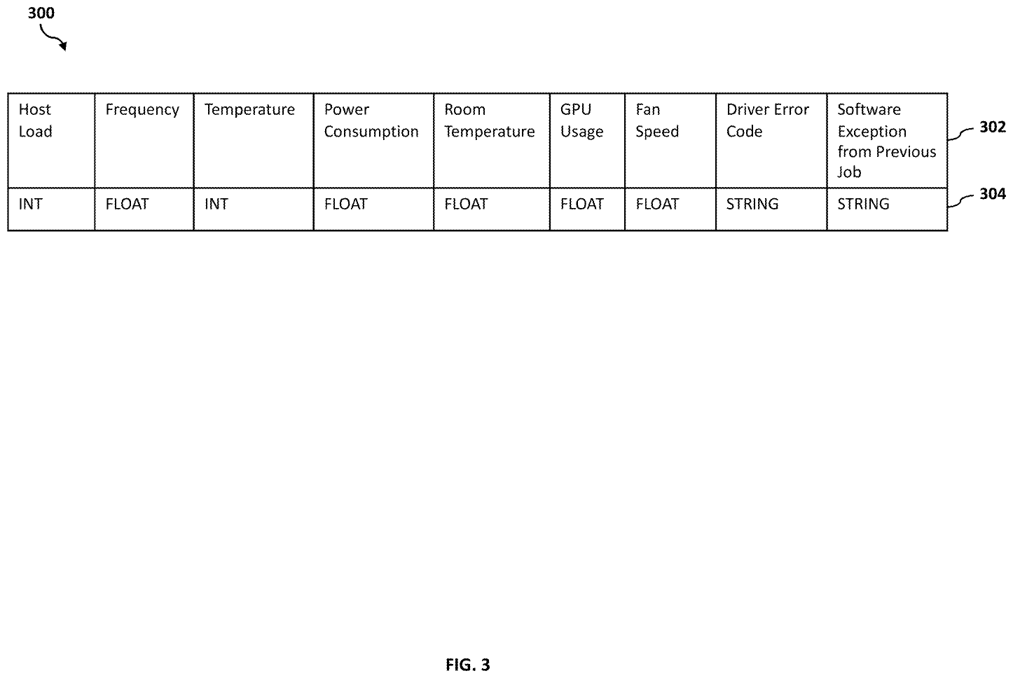

As described above, the autoencoder neural network (e.g., DNN autoencoder) may be trained based on host load, frequency, temperature, room temperature, GPU usage, fan speed, driver error code, and/or software exception from a previous job, among other feature names which may be used to construct the learning model. The training features may be described in more detail with respect to FIG. 3 below.

The autoencoder neural network may be trained based on normal hybrid cloud operation(s) and multiple autoencoder neural network models may be trained per queue, per device type, and/or per environment to achieve better results.

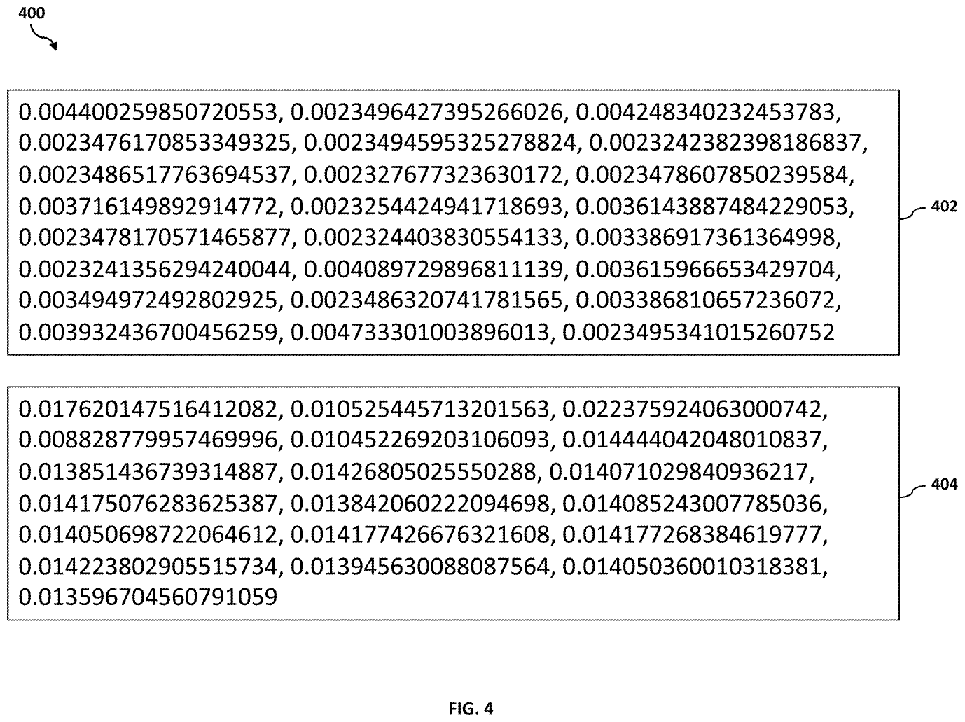

The autoencoder neural network model(s) may make up an ensemble method (e.g., an ensemble of autoencoder neural networks) which may run checks by analyzing metrics (e.g., hardware metrics and/or software exceptions, among other things) collected by an existing monitoring system and by providing a score. A monitoring system providing metrics for the autoencoder neural network(s) may be a component of the hybrid cloud environment which may monitor CPU, GPU, fan speed, and/or storage performance, among other things. The score may be an integer value representing an aggregate of all scores generated by each of the machine learning models which together comprise the ensemble method. The score may be compared to a threshold value (e.g., a go/no-go) which may indicate whether the host can handle the user-submitted job. The threshold value may be user-defined and/or may be based on data from a subject matter expert. An example score is discussed in more detail with respect to FIG. 4 below.

At 208, the host validation program 110a, 110b determines that the selected host can run the workload. The determination may be based on classifications of the host's subsystems, as described previously with respect to step 206 above.

The score generated by the autoencoder neural network(s), as described previously with respect to step 206 above, may be translated into a Boolean value of 0 or 1 which may indicate whether or not to execute the user-scheduled job on the selected host or to look for a different host. If a different host is sought, then the host validation program 110a, 110b may once again perform an analysis of the log files provided by the subsystems of the hybrid cloud environment, as described with respect to step 202 above, and use the ensemble-based autoencoder neural network and/or other statistical or deep learning model (e.g., depending on implementation) to score a next best host.

At 210, the user-submitted job runs on the selected host.

If, at 208, the host validation program 110a, 110b determined that the selected host could not run the workload, then at 204, the scheduler would have selected another host or another cloud environment on which to run the workload associated with the submitted job. In an instance where the selected host is determined to not able to run the workload, the host is labeled “anomalous” by the system and the process is repeated to find a new host and/or a closest fit host (i.e., node).

Another cloud environment may be utilized in instances where the selected host may not run the workload as the host validation program 110a, 110b may access information relating to capabilities of other environments. For example, where the hybrid cloud environment does not include a host which can accommodate the user-submitted job, the scheduler component of the hybrid cloud environment may communicate with a second scheduler of a second hybrid cloud environment to select an appropriate host.

If, at 208, the host validation program 110a, 110b determined that the selected host could not run the workload, then at 204, the scheduler would have selected another host on which to run the workload associated with the submitted job. In an instance where the selected host is determined to not able to run the workload, the host is labeled “anomalous” by the system and the process is repeated to find a new host and/or closest fit node.

Referring now to FIG. 3, an exemplary illustration of training features of an autoencoder neural network 300 according to at least one embodiment is depicted. The illustrated training features of the autoencoder neural network 300 denotes both sample feature names 302 used to construct the autoencoder neural network and datatypes of the features 304. The sample feature names 302 may be modified based on implementation and may include more or fewer features as well as different features.

For example, the autoencoder neural network may be trained on a dataset having datatypes which may be features used for training. A machine learning engineer and/or subject matter expert may optionally, and/or additionally, generate additional datatypes (i.e., features) which may result in a retraining of the autoencoder neural network for improved accuracy.

Referring now to FIG. 4, an exemplary illustration of a score generated by an autoencoder neural network 400 according to at least one embodiment is depicted. As described previously, an autoencoder may be a neural network, trained on software logs, which recreates an original input with a high accuracy when trained. If, however, the autoencoder encounters an unseen input then the host validation program 110a, 110b may be unable to recreate the input which is represented as a large distance from the normal input (e.g., an input which is an anomaly). The illustrated score generated by an autoencoder neural network 400 denotes both a normal input 402 and an anomalous input 404 as comma separated distances. As can be seen from the numerical distance values, the anomalous input 404 is ten times larger than the normal input 402.

Referring now to FIG. 5, an exemplary illustration of a dataset on which named entity detection may be trained 500 according to at least one embodiment is depicted. As described previously, in order to extract entities from the unstructured text (e.g., from the user-submitted job), named entity detection (e.g., entity extraction) may need domain adaptation so that the entity extraction technique may be run on job scripts. In this case, the entity detection technique may be trained using relevant components of the hybrid cloud environment (e.g., details which may be utilized in selecting a host on which to run the user-submitted job). As can be seen from the example dataset on which named entity detection may be trained 500, the number of CPUs and GPUs, as well as many other components, may be extracted from the job scripts of the user-submitted job.

It may be appreciated that FIGS. 2 through 5 provide only an illustration of one embodiment and do not imply any limitations with regard to how different embodiments may be implemented. Many modifications to the depicted embodiment(s) may be made based on design and implementation requirements.

FIG. 6 is a block diagram 900 of internal and external components of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 6. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the host validation program 110a in client computer 102, and the host validation program 110b in network server 112, may be stored on one or more computer-readable tangible storage devices 916 for execution by one or more processors 906 via one or more RAMs 908 (which typically include cache memory). In the embodiment illustrated in FIG. 6, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the host validation program 110a and 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the host validation program 110a in client computer 102 and the host validation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the host validation program 110a in client computer 102 and the host validation program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

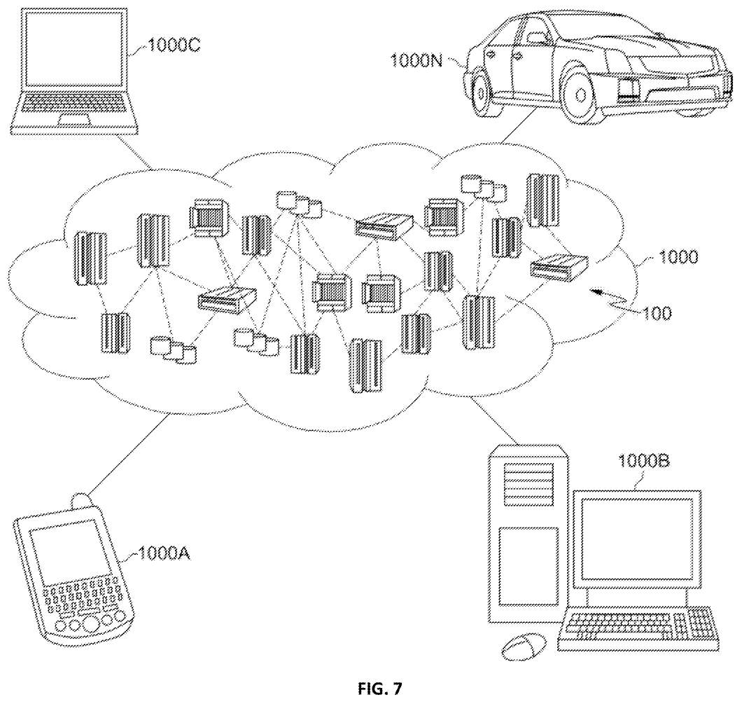

Referring now to FIG. 7, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 7 are intended to be illustrative only and that computing nodes 100 and cloud computing environment 1000 can communicate with any type of computerized device over any type of network and/or network addressable connection (e.g., using a web browser).

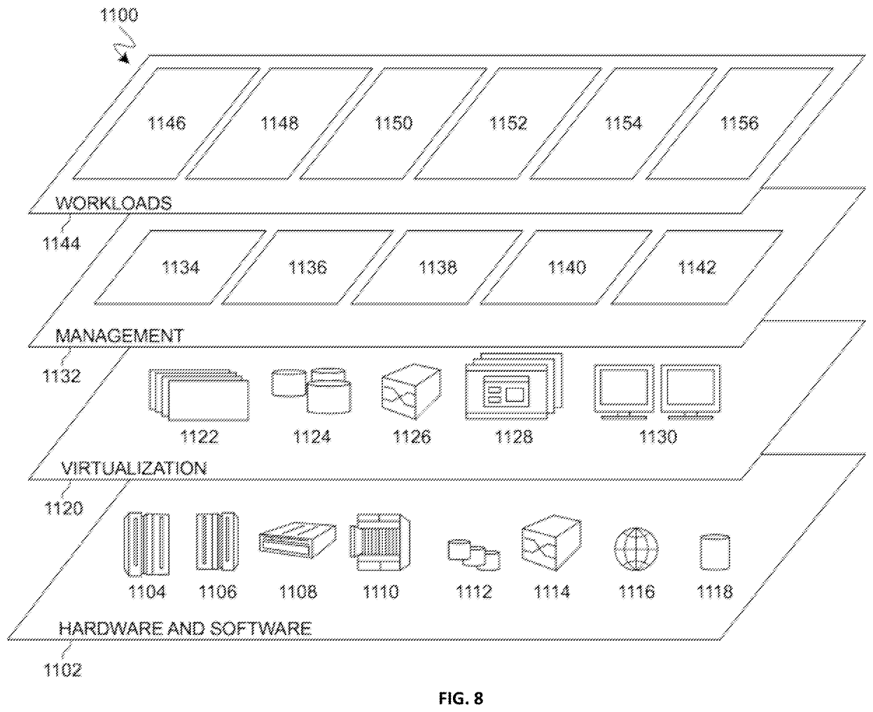

Referring now to FIG. 8, a set of functional abstraction layers 1100 provided by cloud computing environment 1000 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and host validation 1156. A host validation program 110a, 110b provides a way to dynamically determine which hosts present an anomaly with respect to workload requirements based on a neural network classification, and then feed this information back into the scheduler so that jobs may not be scheduled on faulty (e.g., malfunctioning) !hosts.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for host validation, the method comprising:
receiving a job from a user;
selecting, by a scheduler, a host in a hybrid cloud environment to run the received job;
classifying, by a learning component, the selected host's subsystems; and
determining, based on the classification, that the selected host can run the received job.

2. The method of claim 1, wherein the received job further comprises:
a plurality of computational requirements identified using entity extraction; and
a command to be executed.

3. The method of claim 2, wherein selecting, by the scheduler, the host in the hybrid cloud environment to run the received job further comprises:
considering the plurality of computational requirements of the received job and at least one capability of the host in the hybrid cloud environment.

4. The method of claim 2, wherein classifying, by the learning component, the selected host's subsystems before execution of the received job based on the plurality of computational requirements.

5. The method of claim 1, further comprising:
running the received job on the selected host.

6. The method of claim 1, wherein the autoencoder is trained based on hardware metrics and software exceptions.

7. The method of claim 1, further comprising:
identifying an anomalous host based on a plurality of data provided by at least one monitoring system.

8. A computer system for host validation, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a job from a user;
selecting, by a scheduler, a host in a hybrid cloud environment to run the received job;
classifying, by a learning component, the selected host's subsystems; and
determining, based on the classification, that the selected host can run the received job.

9. The computer system of claim 8, wherein the received job further comprises:
a plurality of computational requirements identified using entity extraction; and
a command to be executed.

10. The computer system of claim 9, wherein selecting, by the scheduler, the host in the hybrid cloud environment to run the received job further comprises:
considering the plurality of computational requirements of the received job and at least one capability of the host in the hybrid cloud environment.

11. The computer system of claim 9, wherein classifying, by the learning component, the selected host's subsystems before execution of the received job based on the plurality of computational requirements.

12. The computer system of claim 8, further comprising:
running the received job on the selected host.

13. The computer system of claim 8, wherein the autoencoder is trained based on hardware metrics and software exceptions.

14. The computer system of claim 8, further comprising:
identifying an anomalous host based on a plurality of data provided by at least one monitoring system.

15. A computer program product for host validation, comprising:
one or more non-transitory computer-readable storage media and program instructions stored on at least one of the one or more tangible storage media, the program instructions executable by a processor to cause the processor to perform a method comprising:
receiving a job from a user;
selecting, by a scheduler, a host in a hybrid cloud environment to run the received job;
classifying, by a learning component, the selected host's subsystems; and
determining, based on the classification, that the selected host can run the received job.

16. The computer program product of claim 15, wherein the received job further comprises:
a plurality of computational requirements identified using entity extraction; and
a command to be executed.

17. The computer program product of claim 16, wherein selecting, by the scheduler, the host in the hybrid cloud environment to run the received job further comprises:
considering the plurality of computational requirements of the received job and at least one capability of the host in the hybrid cloud environment.

18. The computer program product of claim 16, wherein classifying, by the learning component, the selected host's subsystems before execution of the received job based on the plurality of computational requirements.

19. The computer program product of claim 15, wherein the autoencoder is trained based on hardware metrics and software exceptions.

20. The computer program product of claim 15, further comprising:
identifying an anomalous host based on a plurality of data provided by at least one monitoring system.
